(19) United States
(12) Patent Application Publication
(10) Pub. No.: US 2013/0076127 A1
(43) Pub. Date: Mar. 28, 2013

(54) POWER SOURCE APPARATUS AND VEHICLE EQUIPPED WITH THE POWER SOURCE APPARATUS

(71) Applicant: Sanyo Electric Co., Ltd., Moriguchi City (JP)

(72) Inventors: Tomonori Kunimitsu, Himeji City (JP); Tsuyoshi Watanabe, Gifu City (JP); Kuniho Tanaka, Kasai City (JP)

(73) Assignee: SANYO ELECTRIC CO., LTD., Moriguchi City (JP)

(21) Appl. No.: 13/628,276

(22) Filed: Sep. 27, 2012

(30) Foreign Application Priority Data
Sep. 28, 2011 (JP) 2011-213495

(51) Int. Cl. H02J 9/00; B60L 1/00

(52) U.S. Cl. 307/9.1; 307/64

(57) ABSTRACT

The power source apparatus is provided with a plurality of battery blocks 1 having high-voltage battery assemblies 2 with chargeable batteries 11 connected together, voltage detection circuitry 4 to detect voltage via detection lines 17 connected to the batteries 11 that make up the high-voltage battery assemblies 2, and central processing units (CPUs) 5 to compute battery 11 state from the voltages detected by the voltage detection circuitry 4 and to issue battery 11 state signals to externally connected electrical equipment. Battery blocks 1 are main battery blocks 1A with CPUs 5 installed, and sub-battery blocks 1B connected to the main battery blocks 1A via connecting lines 9 and having no CPUs 5. The main battery block 1A detects the voltages of batteries 11 that make up a high-voltage battery assembly 2 in the sub-battery block(s) 1B.

### BACKGROUND OF THE INVENTION

1. Field of the Invention

The present invention relates to a power source apparatus with a plurality of battery blocks connected in series or parallel to increase output, and in particular, to a power source apparatus where each battery block is provided with circuitry to detect battery voltages, and to a vehicle equipped with the power source apparatus.

2. Description of the Related Art

A power source apparatus required to output high power has a plurality of battery blocks connected in series or parallel to increase the output voltage and current. This type of power source apparatus can have a plurality of battery blocks connected in series to increase output voltage and/or a plurality of battery blocks connected in parallel to increase output current. The battery blocks have high-voltage battery assemblies with a plurality of batteries connected in series to increase voltage. This type of power source apparatus is primarily used in vehicles such as hybrid vehicles, plug-in hybrid vehicles, and electric vehicles, or is used to store power from solar cells or wind power generation.

Since this type of power source apparatus is made up of many batteries, protection of each battery from over-charging and over-discharging can prevent individual battery degradation, improve the margin of safety, and increase battery lifetime. To achieve this, each battery block is provided with voltage detection circuitry to detect the voltage of each battery in a high-voltage battery assembly.

Refer to Japanese Laid-Open Patent Publication 2006-353020.

A battery block provided with voltage detection circuitry detects battery condition by detecting the voltage of each battery, and controls charging and discharging current to prevent over-charging and over-discharging in each battery. If the voltage of any one of the batteries exceeds a preset maximum voltage during battery block charging, high-voltage battery assembly charging current is limited or cut-off to prevent battery over-charging. Similarly, if the voltage of any one of the batteries drops below a minimum voltage during discharging, discharge current is limited or cut-off to prevent over-discharging of that battery. In addition, remaining charge capacity can be detected from battery voltage, and battery block charging and discharging current can be controlled according to the remaining charge capacity.

A battery block, which has high-voltage battery assemblies made up of a plurality of batteries, is provided with voltage detection circuitry that detects battery voltage via detection wires connected to the batteries, and a central processing unit (CPU) that processes output signals from the voltage detection circuitry. The CPU computes battery voltage from the voltage difference between connection nodes of the voltage detection circuitry, controls a multiplexer and analog-to-digital (A/D) converter provided in the voltage detection circuitry, and/or controls a cooling mechanism that cools battery block high-voltage battery assemblies. Further, the CPU judges battery over-charging and over-discharging from the detected battery voltage, and outputs conditions in the battery block to externally connected electrical equipment. The externally connected electrical equipment controls charging and discharging of the high-voltage battery assemblies that make up the battery block based on signals output from the battery block.

Since the power source apparatus described above has voltage detection circuitry and a CPU provided in each battery block, a power source apparatus made up of many battery blocks has the drawback of high overall cost. Further, a high output voltage power source apparatus does not connect high-voltage battery assembly ground lines to the chassis ground of the vehicle, but rather adopts a circuit structure isolated from chassis ground to avoid electric shock. Meanwhile, external electrical equipment connected to the power source apparatus is grounded to chassis ground to insure stable operation and prevent noise-induced errors. Consequently, it is necessary for a high output voltage power source apparatus to isolate signals that are output to externally connected electrical equipment. As a result, a high output voltage power source apparatus has isolation circuitry added to the output-side to isolate output signals. Output signals are sent from isolation circuitry, which have ground lines isolated from chassis ground, to externally connected electrical equipment, which is grounded to chassis ground. Therefore, this type of power source apparatus requires voltage detection circuitry, a CPU, and isolation circuitry for each battery block, and has the drawbacks that circuitry becomes complex and parts-cost becomes high.

The present invention was developed with the object of correcting the drawbacks described above. Thus, it is a primary object of the present invention to provide a power source apparatus and vehicle equipped with the power source apparatus that has a plurality of battery blocks with high-voltage battery assemblies, and a circuit structure that markedly simplifies high-voltage battery assembly overall circuit structure to reduce total cost while allowing voltage detection for the batteries that make up each battery block high-voltage battery assembly.

### SUMMARY OF THE INVENTION

The power source apparatus of the present invention is provided with a plurality of battery blocks 1 having high-voltage battery assemblies 2 made up of chargeable batteries 11 connected in series or parallel, voltage detection circuitry 4 to detect battery voltage via detection lines 17 connected to the batteries 11 that make up the high-voltage battery assemblies 2, and central processing units (CPUs) 5 to compute battery 11 state from the voltages detected by the voltage detection circuitry 4 and to issue battery 11 state signals to externally connected electrical equipment. Battery blocks 1 are main battery blocks 1A with CPUs 5 installed, and sub-battery blocks 1B connected to the main battery blocks 1A via connecting lines 9 and having no CPUs 5.

In this power source apparatus, a main battery block 1A detects the voltages of batteries 11 that make up a high-voltage battery assembly 2 in the sub-battery block 1B.

The power source apparatus described above is configured with a plurality of battery blocks. Although the power source apparatus has a circuit structure that detects the voltages of the batteries in each battery block high-voltage battery assembly and outputs that data to externally connected electrical equipment, the high-voltage battery assemblies are characterized by an exceedingly simple overall circuit structure that can reduce total cost. This is because the voltages of the batteries that make up each battery block high-voltage battery assembly can be detected without providing a CPU in each sub-battery block. The power source apparatus has a plurality of batteries connected in series to form a high-voltage battery assembly, and a plurality of high-voltage battery assemblies are in-turn connected to increase output. While the overall power source apparatus has many batteries, battery voltages can be detected and data signals can be sent to externally connected electrical equipment with a simple circuit structure having a limited number of CPUs and isolation circuits. Although this power source apparatus is made up of many batteries with significant battery cost, it has the outstanding characteristic that charging and discharging can be performed while detecting battery state and preventing over-charging and over-discharging via an overall circuit structure that is remarkably simple and can reduce the parts-cost.

In the power source apparatus of the present invention, high-voltage battery assembly 2 ground lines can be isolated from chassis (vehicle) ground, and an isolation circuit 7 can be housed in each main battery block 1A to isolate battery state signals output to externally connected electrical equipment grounded to the chassis ground. This power source apparatus can reduce the number of isolation circuits, which isolate output signals sent to externally connected electrical equipment, as well as the number of CPUs, and has the characteristic that parts-cost and total cost can be reduced.

In the power source apparatus of the present invention that uses the high-voltage battery assemblies 2 as a vehicle power source apparatus to supply power to a motor that drives the vehicle, the main battery block 1A can output battery 11 state signals to the vehicle-side.

In the power source apparatus of the present invention, the connecting lines 9 that connect a main battery block 1A and sub-battery block 1B can be the detection lines 17 that transmit voltage signals, which are detected by sub-battery block 1B voltage detection circuitry 4, to the main battery block 1A. This power source apparatus has the characteristic that sub-battery block circuit structure can be simplified even more. This is because the sub-battery block can send voltage signals for battery voltage detection to the main battery block via the detection lines, and the voltages of all the batteries can be detected in the main battery block.

In the power source apparatus of the present invention, the connecting lines 9 that connect a main battery block 1A and sub-battery block 1B can be a control line 16 to send control signals from the main battery block 1A to the voltage detection circuitry 4 in the sub-battery block 1B, and a voltage signal line 14 to send voltage signals from the sub-battery block 1B voltage detection circuitry 4 to the main battery block 1A. The main battery block in this power source apparatus can detect the voltages of all the batteries in the sub-battery block with a reduced number of voltage signal lines. This is because the battery for voltage detection in the sub-battery block can be designated via the control line, and the voltage of the designated battery can be sent to the main battery block via the voltage signal line.

In the power source apparatus of the present invention, voltage detection circuitry 4 in the sub-battery block 1B can be provided with a multiplexer 13 to switch the battery 11 for voltage detection in the high-voltage battery assembly 2. Since the voltages of a plurality of batteries can be detected by multiplexer switching, this power source apparatus can detect the voltages of many batteries with a simple circuit.

In the power source apparatus of the present invention, voltage detection circuitry 4 in a sub-battery block 1B can be provided with a multiplexer 13 to switch the battery 11 for voltage detection in the high-voltage battery assembly 2, and an A/D converter 15 to convert multiplexer 13 output to a digital signal. Voltage signals converted to digital signals by the A/D converter 15 can be transmitted to the main battery block 1A via the voltage signal line 14. Since the voltages of a plurality of batteries can be detected by multiplexer switching and the detected signals can be converted to digital signals for transmission to the main battery block, voltages of the batteries that make up the sub-battery block high-voltage battery assembly can be accurately transmitted from the sub-battery block to the main battery block. This is because voltage signals are sent from the sub-battery block to the main battery block as digital signals.

The power source apparatus of the present invention can be further provided with a cooling plate 3 having a main battery block 1A and sub-battery block 1A attached in a thermally coupled manner, and the CPU 5 in the main battery block 1A can control cooling by the cooling plate 3. This power source apparatus can control the state of cooling of the main battery block and sub-battery block attached to the cooling plate with the CPU in the main battery block. Therefore, a special-purpose CPU is not necessary to control cooling by the cooling plate, and the power source apparatus has the characteristic that overall structure (including the cooling mechanism) can be simplified. Specifically, batteries in a plurality of battery blocks attached to a single cooling plate can be cooled under favorable conditions by the CPU used to detect the voltages of all the batteries in the battery blocks on that cooling plate.

The power source apparatus of the present invention can be further provided with a plurality of battery units 10, and each battery unit 10 can be made up of a sub-battery block 1B and a main battery block 1A mounted on a cooling plate 3.

The power source apparatus of the present invention can be a power source apparatus used in a power storage application.

The vehicle of the present invention can be provided with any one of the power source apparatus cited above. The above and further objects of the present invention as well as the features thereof will become more apparent from the following detailed description to be made in conjunction with the accompanying drawings.

### BRIEF DESCRIPTION OF THE DRAWINGS

FIG. 1 is an abbreviated oblique view of a power source apparatus for an embodiment of the present invention;

FIG. 2 is a block diagram of the power source apparatus shown in FIG. 1;

FIG. 3 is a block diagram of a power source apparatus for another embodiment of the present invention;

FIG. 4 is a block diagram of a power source apparatus for another embodiment of the present invention;

FIG. 5 is an abbreviated plan view of a power source apparatus for another embodiment of the present invention;

FIG. 6 is a block diagram showing an example of a hybrid vehicle, which is driven by a motor and an engine, equipped with a power source apparatus;

FIG. 7 is a block diagram showing an example of an electric vehicle, which is driven by a motor only, equipped with a power source apparatus; and

FIG. 8 is a block diagram showing an example of a power source apparatus used in a power storage application.

### DETAILED DESCRIPTION OF THE EMBODIMENTS

The following describes embodiments of the present invention based on the figures. However, the following embodiments are merely specific examples of a power source apparatus and vehicle equipped with the power source apparatus representative of the technology associated with the present invention, and the power source apparatus and vehicle of the present invention are not limited to the embodiments described below.

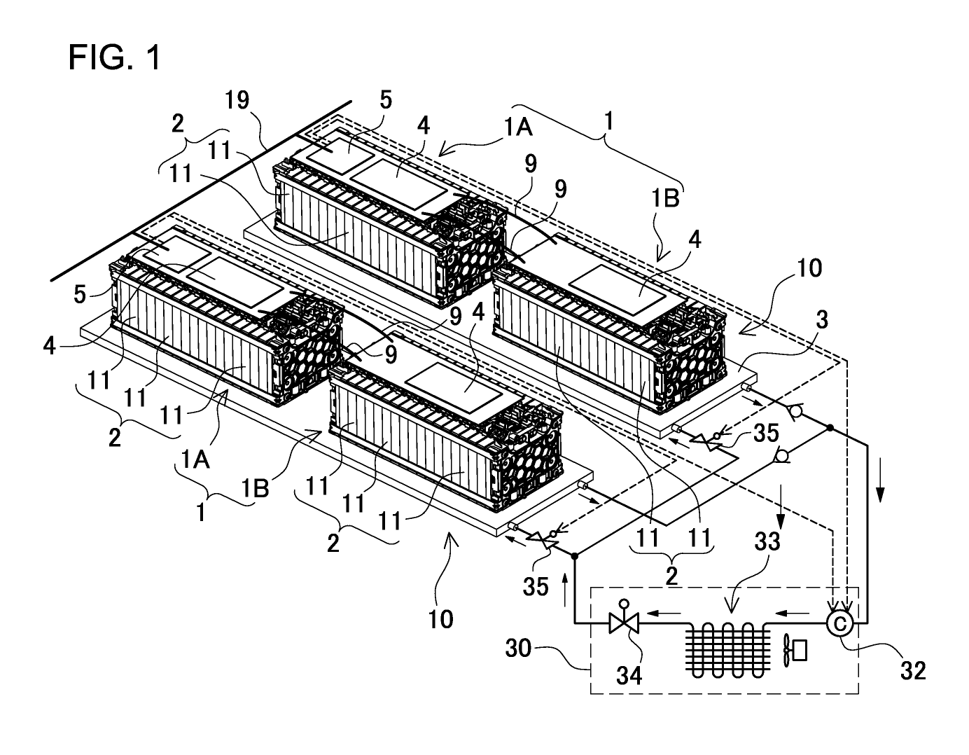

The power source apparatus shown in FIG. 1 is provided with a plurality of battery units 10. In FIG. 1, the power source apparatus has two battery units 10. Each battery unit 10 has a plurality of battery block 1 high-voltage battery assemblies 2 mounted on a cooling plate 3 in a thermally coupled manner. In FIG. 1, each battery unit 10 has two battery blocks 1 mounted on a cooling plate 3. Battery blocks 1 are connected in series or parallel and connected to an output line 19. In the power source apparatus of FIG. 1, the two battery blocks 1 mounted on a cooling plate 3 are connected in series to form a battery unit 10, and the battery units 10 are in-turn connected in parallel. However, the battery blocks that make up a battery unit could also be connected in parallel, and the battery units could be connected in series.

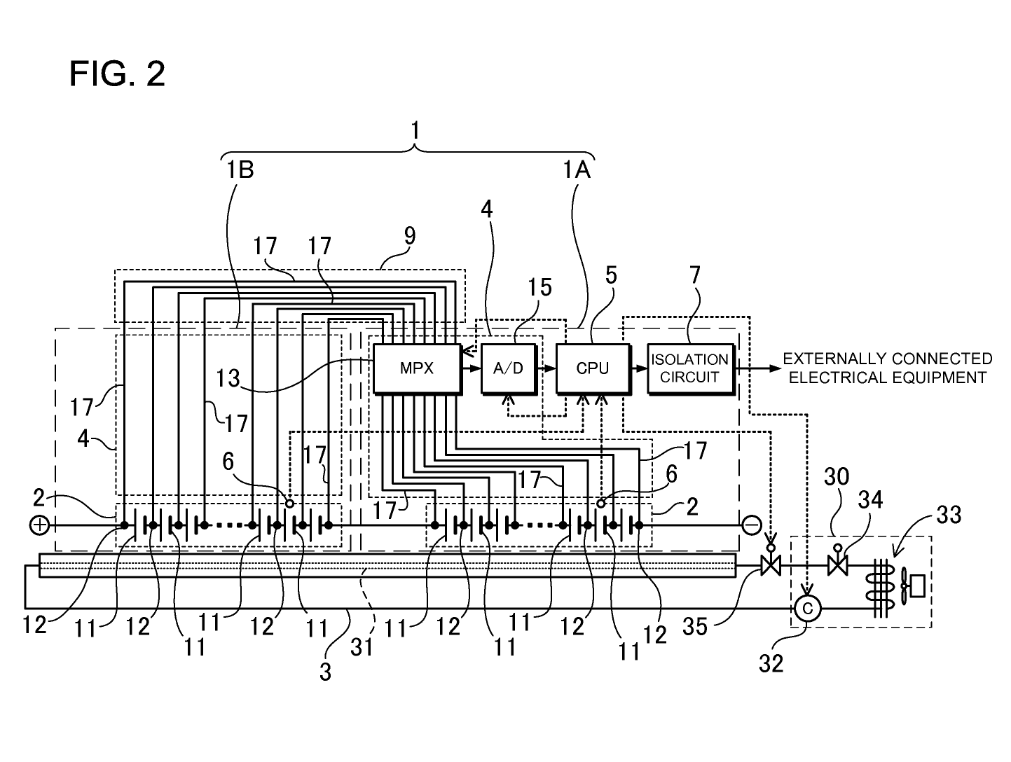

FIGS. 2-4 show block diagrams of a power source apparatus. The power source apparatus shown in these and other figures is provided with high-voltage battery assemblies 2 having a plurality of batteries 11 connected in series, and voltage detection circuitry 4 that detects voltage via detection lines 17 connected to each battery 11 in the high-voltage battery assemblies 2. The power source apparatus detects the voltages of all the batteries 11 that make up the high-voltage battery assemblies 2 with the voltage detection circuitry 4, and is provided with CPUs 5 that compute battery 11 state from the detected voltages and output battery 11 state signals to externally connected electrical equipment. A CPU 5 issues battery state signals to externally connected electrical equipment that is data including battery 11 voltage, over-charging, over-discharging, or remaining charge capacity information. Note that voltage detection circuitry can adopt various voltage detection schemes such as detection of the voltage of each battery, or detection of voltage differences with respect to a single reference node. In addition, the voltage detection scheme does not necessarily have to detect the voltages of all the batteries, and computation of the battery state may not be required.

In a power source apparatus installed in a vehicle such as a hybrid vehicle, a plug-in hybrid vehicle, or an electric vehicle and used to supply power to a motor that drives the vehicle, the externally connected electrical equipment is the vehicle control system. Accordingly, the power source apparatus in this application sends battery state signals to the vehicle-side control system. Similarly, in a power source apparatus used to store power converted from renewable energy sources by energy conversion devices such as solar cells or wind power generating systems, the externally connected electrical equipment is the power storage apparatus controller. Accordingly, the power source apparatus in this application sends state of charge signals to the power storage apparatus controller.

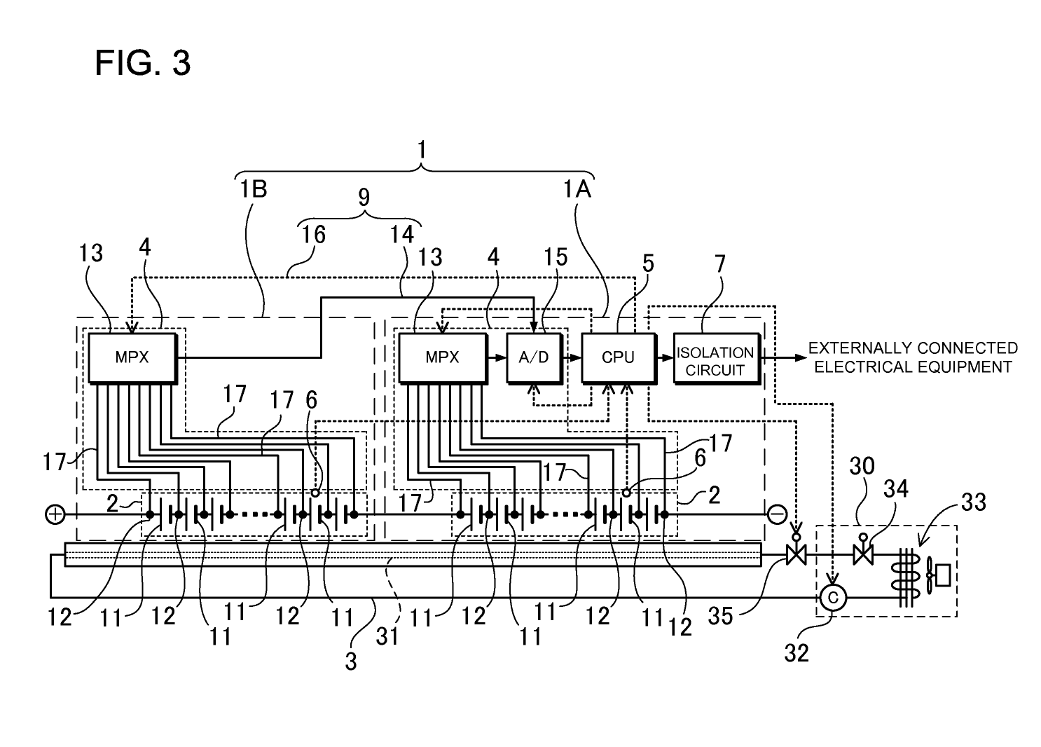

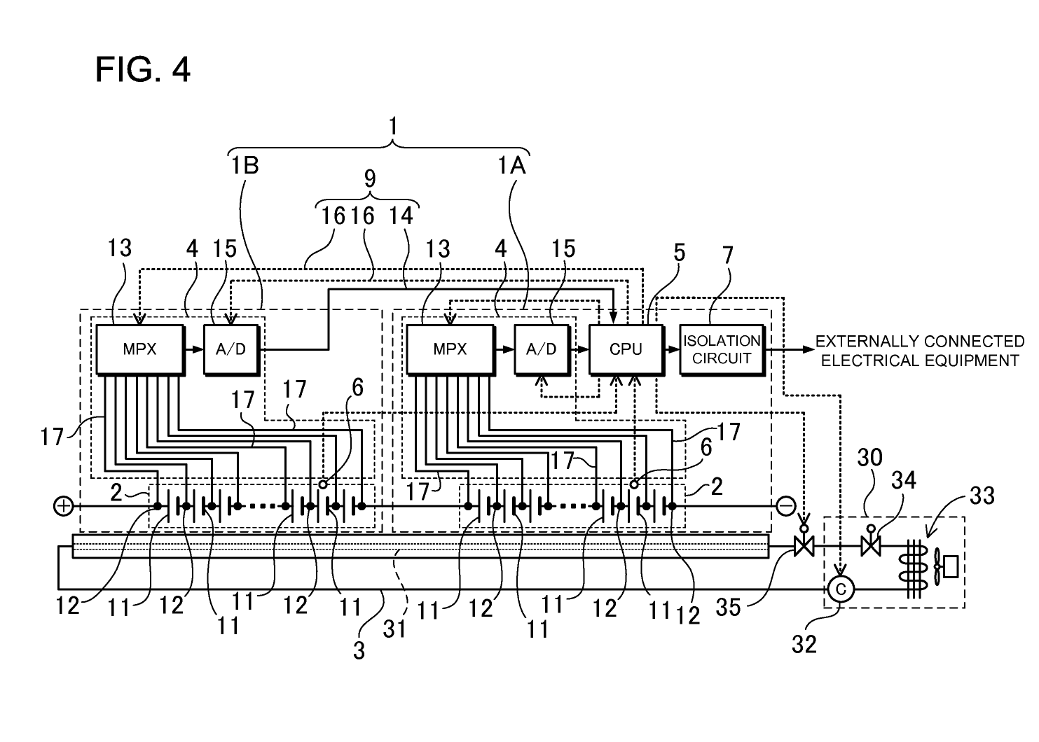

Battery blocks 1 mounted on a cooling plate 3 are made up of a main battery block 1A carrying a CPU 5 that processes output from the voltage detection circuitry 4, and a sub-battery block 1B connected to the main battery block 1A via connecting lines 9 and containing no CPU 5. The main battery block 1A detects the voltages of the batteries 11 that make up the high-voltage battery assembly 2 in the sub-battery block 1B via the connecting lines 9. In the power source apparatus of FIGS. 2 and 3, voltage detection circuitry 4 in the main battery block 1A detects the voltages of the batteries 11 in the sub-battery block 1B high-voltage battery assembly 2 through connecting lines 9. In the power source apparatus of FIG. 4, voltage detection circuitry 4 in the sub-battery block 1B detects the voltages of the batteries 11 in the sub-battery block 1B high-voltage battery assembly 2, and voltage detection circuitry 4 in the main battery block 1A acquires those detected battery 11 voltages via the connecting lines 9. In addition, voltage detection circuitry in the main battery block 1A detects the voltages of the batteries 11 that make up the high-voltage battery assembly 2 in the main battery block 1A. Namely, the main battery block 1A detects the voltages of the batteries 11 in all the high-voltage battery assemblies 2. More specifically, in the embodiments of the power source apparatus, the main battery block 1A detects the voltages of the batteries in all the high-voltage battery assemblies 2 via voltage detection circuitry 4 in the main battery block 1A and via the connecting lines 9. The power source apparatus is configured to use the voltage detection results to compute the state of each battery 11 with the CPU 5 installed in the main battery block 1A.

Main battery blocks 1A and sub-battery blocks 1B are provided with high-voltage battery assemblies 2 having a plurality of batteries 11 connected in series. High-voltage battery assemblies 2 in the power source apparatus of FIG. 1 are rectangular batteries held together in stacks with the electrode terminals of adjacent batteries connected together for series connection. The rectangular batteries 11 are lithium ion batteries. However, any chargeable batteries such as lithium polymer batteries or nickel hydride batteries can also be used as the batteries in a high-voltage battery assembly.

High-voltage battery assemblies 2 are mounted on cooling plates 3 in a thermally coupled manner. Although not illustrated, the bottom surface of each battery 11 in a high-voltage battery assembly 2 connects with the upper surface of the cooling plate 3 in a thermally coupled manner through thermally conducting sheet or thermal paste (heat transfer compound). A cooling plate 3 has a main battery block 1A and sub-battery block 1B attached in a thermally coupled manner. In the power source apparatus of FIG. 1, one main battery block 1A and one sub-battery block 1B are mounted on each cooling plate 3. However, the power source apparatus of the present invention could also have one main battery block and a plurality of sub-battery blocks mounted on a cooling plate. Even in the case of one main battery block and a plurality of sub-battery blocks, the CPU installed in the main battery block is configured to compute the state of each battery. In practice, connecting lines for this arrangement can be directly connected from each sub-battery block to the main battery block, or the sub-battery blocks can be connected in a cascaded manner (the sub-battery block on the end is connected to the main battery block via relay through adjacent sub-battery blocks). In the case of a cascade connection scheme, connecting lines join adjacent sub-battery blocks, but ultimately all signals are transmitted or relayed to the CPU in the main battery block. In general, for practical circuit board implementation of the voltage detection circuitry (even when it includes a multiplexer or A/D converter), all functions are integrated into a single-chip application specific integrated circuit (ASIC). Since the ASIC chip in this type of implementation can also have communication capability, connecting lines in the embodiments are connected to the ASIC chips. For connecting lines directly connected from each sub-battery block to the main battery block, the ASIC chip in the main battery block requires a plurality of inputs to connect the connecting lines. However, in a cascade arrangement, all ASIC chips can have one connecting line input, and parts-commonality can be realized for ASIC chips in all the battery blocks.

The cooling plate 3 cools battery block 1 high-voltage battery assemblies 2, which are mounted in a thermally coupled manner on the cooling plate 3, by forced cooling. Cooling conditions of the cooling plate 3 are controlled by the CPU 5 in the main battery block 1A. The CPU 5 detects battery temperature of the high-voltage battery assemblies 2 via temperature sensors 6 to control cooling plate 3 cooling conditions. When high-voltage battery assembly 2 temperature exceeds a set temperature, the CPU 5 circulates coolant through the cooling plate 3, and when high-voltage battery assembly 2 temperature drops below the set temperature, circulation of coolant through the cooling plate 3 is stopped.

The cooling plate 3 is forcibly cooled by a cooling mechanism 30. The cooling plate 3 is provided with coolant passageways 31 that circulate coolant through the inside of the cooling plate 3. Coolant such as Freon (DuPont trade name for chlorofluorocarbons) or carbon dioxide is supplied to the coolant passageways 31 in liquid form, evaporates inside the coolant passageways 31, and cools the cooling plate 3 via the heat of vaporization. The coolant passageways 31 of the cooling plate 3 are connected to the cooling mechanism 30.

The cooling mechanism 30 is provided with a compressor 32 that compresses coolant vaporized inside the coolant passageways 31, a heat exchanger 33 that cools and liquefies coolant compressed by the compressor 32, and an expansion valve 34 that supplies coolant liquefied by the heat exchanger 33 to the coolant passageways 31. Coolant is supplied from the expansion valve 34 in the liquid state, evaporates in the coolant passageways 31 inside the cooling plate 3 to cool the cooling plate 3 via the heat of vaporization, and is discharged back to the cooling mechanism 30. Namely, the coolant circulates between the coolant passageways 31 in the cooling plate 3 and the cooling mechanism 30 to cool the cooling plate 3. Although this cooling mechanism 30 cools the cooling plate 3 to a low temperature via the coolant's heat of vaporization, the cooling plate can also be cooled without depending on the heat of vaporization. In such a system, coolant such as brine solution cooled to a low temperature is supplied to the coolant passageways to directly cool the cooling plate via the low temperature of the coolant rather than by the heat of vaporization.

The CPU 5 controls the compressor 32 and regulating valve 35 connected to the coolant passageways 31 to control cooling conditions for the cooling plate 3. When high-voltage battery assembly 2 temperature detected by the temperature sensor 6 exceeds the set temperature, the CPU 5 activates the compressor 32 and opens the regulating valve 35 to supply coolant to the coolant passageways 31 in the cooling plate 3. The power source apparatus of FIG. 1 has two battery units 10, and the coolant passageways 31 in the cooling plate 3 of each battery unit 10 connect to the cooling mechanism 30 via a regulating valve 35. By controlling opening and closing of the regulating valve 35 connected to the coolant passageways 31 in the cooling plate 3 of each battery unit 10, this system can control cooling conditions for a plurality of battery units 10 with a single cooling mechanism 30. Although the power source apparatus described above is equipped with a specially provided cooling mechanism 30 to cool the cooling plates 3, a power source apparatus installed on-board a vehicle can also use the existing cooling system that cools the vehicle interior for the additional purpose of cooling the cooling plates. In the configuration described above, a battery unit 10 made up of a main battery block 1A and a sub-battery block 1B is mounted on a single cooling plate 3. Therefore, cooling mechanism 30 operation, namely compressor 32 and regulating valve 35 operation, can be controlled for appropriate cooling consistent with battery 11 state computed by the CPU 5.

The main battery block 1A CPU 5 detects the voltages of high-voltage battery assemblies 2 in all the battery blocks 1, computes battery 11 state from the detected voltages, and outputs battery 11 state signals to externally connected electrical equipment. Specifically, the CPU 5 determines battery 11 over-charging and over-discharging from the detected voltages, computes battery 11 remaining charge capacity from battery 11 voltage, and issues signals containing those battery 11 data to externally connected electrical equipment.

The battery blocks 1 are not grounded to the vehicle chassis ground to prevent electric shock from the high-voltage battery assemblies 2. However, externally connected electrical equipment that connects with the power source apparatus is grounded to chassis ground. Accordingly, battery 11 state of charge signals issued from a CPU 5 are output to externally connected electrical equipment through an isolation circuit 7. An isolation circuit 7 is disposed at the output-side of the main battery block 1A to isolate signals from the CPU 5 and output those signals to externally connected electrical equipment. The isolation circuit 7 isolates battery 11 state of charge signals via a transformer and outputs those signals to externally connected electrical equipment. However, the isolation circuit can also isolate battery 11 state of charge signals for output to externally connected electrical equipment via other isolation schemes such as those using optical signal transmission devices including a photo-coupler (for example).

The power source apparatus in FIG. 2 has the high-voltage battery assemblies 2 of the main battery block 1A and the sub-battery block 1B mounted on a cooling plate 3. The connecting lines 9 that connect the main battery block 1A and sub-battery block 1B in this power source apparatus are the detection lines 17 that are connected to the batteries 11 that make up the high-voltage battery assembly 2 in the sub-battery block 1B. In the sub-battery block 1B shown in the figure, the voltage detection circuitry 4 is the detection lines 17 connected to the batteries 11 in the high-voltage battery assembly 2 of the sub-battery block 1B. In this power source apparatus, the detection lines 17 of the sub-battery block 1B voltage detection circuitry 4 serve as connecting lines 9, connect with the main battery block 1A voltage detection circuitry 4, and transmit voltage signals for the batteries 11 in the sub-battery block high-voltage battery assembly 2 to the main battery block 1A. One end of the detection lines 17 connects to the positive and negative sides of the high-voltage battery assembly 2 and to connection nodes 12 between each battery 11 in the high-voltage battery assembly 2, and the other end connects to the multiplexer 13 in the voltage detection circuitry 4 of the main battery block 1A. The connecting lines 9, which are the detection lines 17, transmit voltage signals from battery 11 connection nodes 12 including the positive and negative sides of the high-voltage battery assembly 2 in the sub-battery block 1B to the main battery block 1A.

In the main battery block 1A, the CPU 5 computes the potential difference between connection nodes 12 (subtracts adjacent connection node 12 voltages) to determine the voltage of each battery 11. The main battery block 1A is provided with voltage detection circuitry 4 that detects the voltage at connection nodes 12 between batteries 11 in the high-voltage battery assemblies 2, a CPU 5 that processes output from the voltage detection circuitry 4, and an isolation circuit 7 that isolates and transmits output from the CPU 5. The voltage detection circuitry 4 is provided with detection lines 17 connected to the battery 11 connection nodes 12 in the high-voltage battery assemblies 2 of the main battery block 1A and sub-battery block 1B, a multiplexer 13 that sequentially switches the detection lines 17, and an A/D converter 15 that converts multiplexer 13 output to digital signals input to the CPU 5. The CPU 5 computes battery 11 voltage from the voltage difference between adjacent connection nodes 12, and controls the multiplexer 13 and the A/D converter 15. The CPU 5 sequentially switches the multiplexer 13 to input the voltage at each battery 11 connection node 12 in the high-voltage battery assemblies 2 in the sub-battery block 1B and main battery block 1A to the A/D converter 15. Conversion of input analog signals to digital signals by the A/D converter 15 is synchronized with the input of battery 11 connection node 12 voltages, and the converted digital signals are output to the CPU 5. The CPU 5 processes voltage signals input from the A/D converter 15, detects battery 11 voltage, computes remaining charge capacity from the detected battery 11 voltage, detects over-charging and over-discharging, and issues battery 11 state signals to externally connected electrical equipment via the isolation circuit 7.

Turning to FIG. 3, the voltage detection circuitry 4 in the sub-battery block 1B of this power source apparatus is provided with detection lines 17 connected to connection nodes 12 of the batteries 11 in the high-voltage battery assembly 2, and a multiplexer 13 to sequentially switch between the detection lines 17. This power source apparatus is also provided with connecting lines 9 that connect the main battery block 1A and the sub-battery block 1B. The connecting lines 9 are made up of a control line 16 to transmit control signals from the main battery block 1A CPU 5 to the sub-battery block 1B voltage detection circuitry 4, and a voltage signal line 14 to transmit voltage signals from the sub-battery block 1B voltage detection circuitry 4 to the main battery block 1A voltage detection circuitry 4. The control line 16 transmits control signals output from the main battery block 1A CPU 5 to the multiplexer 13 in the sub-battery block 1B voltage detection circuitry 4 to control sequential switching of the multiplexer 13. The voltage signal line 14 transmits voltage signals, which are voltages detected from the plurality of batteries 11 by switching the multiplexer 13 in the sub-battery block 1B voltage detection circuitry 4, to the A/D converter 15 in the main battery block 1A voltage detection circuitry 4.

Turning to FIG. 4, the voltage detection circuitry 4 in the sub-battery block 1B of this power source apparatus is provided with detection lines 17 connected to connection nodes 12 of the batteries 11 in the high-voltage battery assembly 2, a multiplexer 13 to sequentially switch between the detection lines 17, and an A/D converter 15 to convert multiplexer 13 output to a digital signal. The connecting lines 9, which connect the main battery block 1A and the sub-battery block 1B, are made up of control lines 16 to transmit control signals from the main battery block 1A CPU 5 to the sub-battery block 1B voltage detection circuitry 4, and a voltage signal line 14 to transmit voltage signals from the sub-battery block 1B voltage detection circuitry 4 to the main battery block 1A voltage detection circuitry 4. The control lines 16 transmit control signals output from the main battery block 1A CPU 5 to the multiplexer 13 and A/D converter 15 in the sub-battery block 1B voltage detection circuitry 4. The multiplexers 13 are sequentially switched by control signals sent from the CPU 5. The A/D converters 15 convert input analog signals to digital output signals with conversions synchronized with voltage signal input from the multiplexers 13 as directed by control signals from the CPU 5. The voltage signal line 14 transmits digital voltage signals, which are voltages detected from the plurality of batteries 11 by switching the multiplexer 13 in the sub-battery block 1B voltage detection circuitry 4 converted to digital signals by the A/D converter 15, to the main battery block 1A CPU 5.

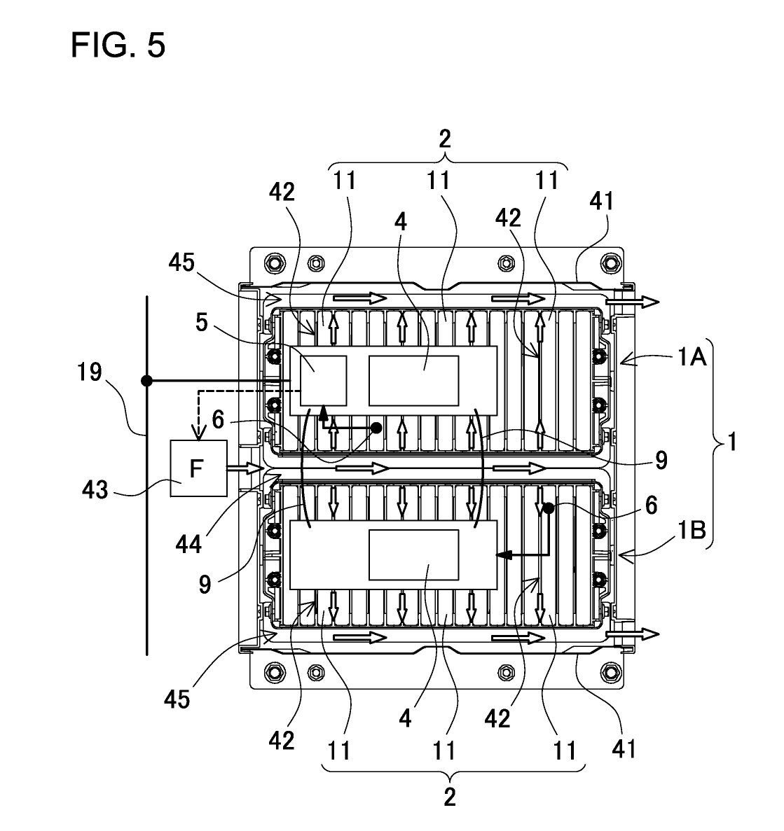

The power source apparatus of the present invention does not necessarily require high-voltage battery assembly cooling via cooling plates. Turning to FIG. 5, an arrangement is shown for cooling the batteries 11 in the high-voltage battery assemblies 2 by establishing cooling gaps 42 between stacked batteries 11 and forcibly ventilating the cooling gaps 42 with cooling gas. Although not illustrated, spacers sandwiched between batteries 11 in the battery blocks 1 shown in FIG. 5 have cooling grooves on both sides, and the cooling grooves establish cooling gaps 42 between the batteries 11 and spacers. Spacer cooling grooves extend in the horizontal direction traversing from side to side across the batteries 11, and cooling gas is induced to flow in the horizontal direction to cool the batteries 11.

To enable cooling gas ventilation through the cooling gaps 42 in the high-voltage battery assemblies 2, the power source apparatus of the figure is also provided with an inlet duct 44 formed between the two rows of battery blocks 1, which are the main battery block 1A and sub-battery block 1A disposed in a parallel orientation, and exhaust ducts 45 formed between the outer case 41 and both sides of the two rows of battery blocks 1. As shown by the arrows in FIG. 5, a forced ventilating device 43 forces cooling gas to flow from the central inlet duct 44 towards the outer exhaust ducts 45 to cool the batteries 11 in the high-voltage battery assemblies 2. Cooling gas forced into the central inlet duct 44 separates and flows through each of the cooling gaps 42. After passing through the cooling gaps 42, cooling gas collects in the exhaust ducts 45 and is discharged outside the power source apparatus.

In this power source apparatus, forced ventilating device 43 operation is controlled by the main battery block 1A CPU 5. The CPU 5 detects high-voltage battery assembly 2 temperature via temperature sensors 6, and controls the forced ventilating device 43 to control ventilating conditions. When high-voltage battery assembly 2 temperature exceeds a set temperature, the CPU 5 activates the forced ventilating device 43 to force the flow of cooling gas and cool the batteries 11. When high-voltage battery assembly 2 temperature drops below the set temperature, the CPU 5 stops forced ventilating device 43 operation.

The power source apparatus described above can be used as a power source on-board a vehicle. An electric powered vehicle such as a hybrid vehicle driven by both an engine and an electric motor, a plug-in hybrid vehicle, or an electric vehicle driven by an electric motor only can be equipped with the power source apparatus and use it as an on-board power source.

### (Power Source Apparatus in a Hybrid Vehicle Application)

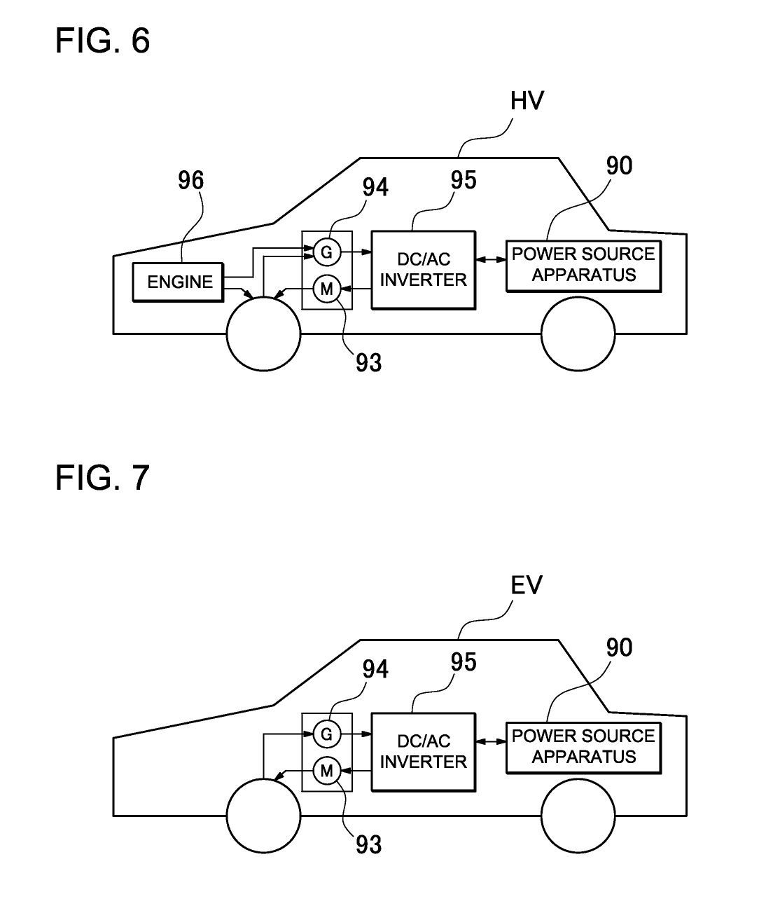

FIG. 6 shows an example of power source apparatus installation on-board a hybrid vehicle, which is driven by both an engine and an electric motor. The vehicle HV equipped with the power source apparatus 90 shown in this figure is provided with an engine 96 and a driving motor 93 to drive the vehicle HV, a power source apparatus 90 to supply power to the motor 93, and a generator 94 to charge the power source apparatus 90 batteries. The power source apparatus 90 is connected to the motor 93 and generator 94 via a direct current-to-alternating current (DC/AC) inverter 95. The vehicle HV runs on both the motor 93 and engine 96 while charging the batteries in the power source apparatus 90. In operating modes where engine efficiency is poor such as during acceleration and low speed cruise, the vehicle is driven by the motor 93. The motor 93 operates on power supplied from the power source apparatus 90. The generator 94 is driven by the engine 96 or by regenerative braking when the vehicle brake pedal is pressed and operates to charge the power source apparatus 90 batteries.

### (Power Source Apparatus in an Electric Vehicle Application)

FIG. 7 shows an example of power source apparatus installation on-board an electric vehicle, which is driven by an electric motor only. The vehicle EV equipped with the power source apparatus 90 shown in this figure is provided with a driving motor 93 to drive the vehicle EV, a power source apparatus 90 to supply power to the motor 93, and a generator 94 to charge the power source apparatus 90 batteries. The power source apparatus 90 is connected to the motor 93 and generator 94 via a DC/AC inverter 95. The motor 93 operates on power supplied from the power source apparatus 90. The generator 94 is driven by energy from regenerative braking and operates to charge the power source apparatus 90 batteries.

### (Power Source Apparatus in a Power Storage Application)

Further, application of the power source apparatus of the present invention is not limited to the power source for the driving motor in a vehicle. The power source apparatus of the present invention can also be used as the power source in a power storage apparatus that stores power by charging batteries with power generated by methods such as solar power or wind power generation. Or, the power source apparatus can be used as the power source in a power storage apparatus that stores power by charging batteries with late-night (reduced-rate) power. A power source apparatus charged by late-night power is charged by surplus power generated by the power plant late at night, and outputs power during the daytime when demand is high. This allows daytime peak-power usage to be limited. The power source apparatus can also be used as a power source that is charged by both solar cell output and late-night power. This type of power source apparatus effectively uses both late-night power and power generated by solar cells, and can take weather conditions and power consumption patterns into consideration to efficiently store power.

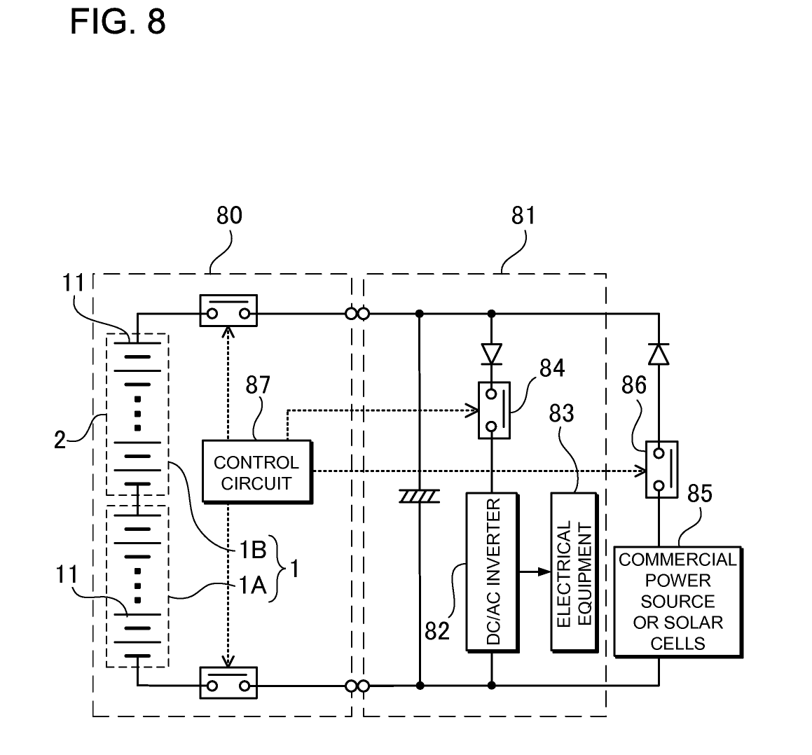

The power storage apparatus shown in FIG. 8 charges power source apparatus 80 batteries 11 with a charging power supply 85 such as a (late-night) commercial power source or solar cells, and discharges power source apparatus 80 batteries 11 to supply power to the DC/AC inverter 82 of a load 81. Accordingly, the power storage apparatus of the figure has a charging mode and a discharging mode. The charging power supply 85 is connected to the power source apparatus 80 via a charging switch 86, and the DC/AC inverter 82 is connected to the power source apparatus 80 via a discharge switch 84. The discharge switch 84 and the charging switch 86 are controlled ON and OFF by a power source apparatus 80 control circuit 87. In the charging mode, the control circuit 87 switches the charging switch 86 ON and the discharge switch 84 OFF to charge the power source apparatus 80 batteries 11 with power supplied from the charging power supply 85. When power source apparatus 80 charging is completed by fully-charging the batteries or by charging to a battery capacity at or above a given capacity, the control circuit 87 switches the charging switch 86 OFF to stop charging. In the discharging mode, the control circuit 87 switches the discharge switch 84 ON and the charging switch 86 OFF to supply power from the power source apparatus 80 to the load 81. The load 81 that is supplied with power from the power source apparatus 80 delivers that power to electrical equipment 83 via the DC/AC inverter 82. When power source apparatus 80 remaining battery capacity drops to a given capacity, the control circuit 87 switches the discharge switch 84 OFF to stop battery discharge. Depending on requirements, the power storage apparatus can also turn ON both the charging switch 86 and the discharge switch 84 to allow power to be simultaneously supplied to the load 81 while charging the power source apparatus 80.

### INDUSTRIAL APPLICABILITY

The power source apparatus of the present invention can be appropriately used as a power source apparatus in a vehicle such as a plug-in hybrid electric vehicle that can switch between an electric vehicle mode and a hybrid vehicle mode, a hybrid (electric) vehicle, and an electric vehicle. The present invention can also be appropriately used in applications such as a server computer backup power source that can be rack-installed, a backup power source apparatus for a wireless base station such as a mobile phone base station, a power storage apparatus for the home or manufacturing facility, a streetlight power source, a power storage apparatus for use with solar cells, and a backup power source in systems such as traffic signals. It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2011-213,495 filed in Japan on Sep. 28, 2011, the content of which is incorporated herein by reference.

What is claimed is:

1. A power source apparatus comprising:
a plurality of battery blocks having high-voltage battery assemblies made up of chargeable batteries connected in series or parallel;
voltage detection circuitry to detect voltages via detection lines connected to the batteries that make up the high-voltage battery assemblies; and
CPUs to compute battery state from the voltages detected by the voltage detection circuitry and to issue battery state signals to externally connected electrical equipment;
wherein the battery blocks comprise:
main battery blocks with CPUs installed; and
sub-battery blocks connected to the main battery blocks via connecting lines and having no CPUs;
wherein the main battery block detects the voltages of batteries that make up a high-voltage battery assembly in the sub-battery block.

2. The power source apparatus as cited in claim 1 wherein battery block high-voltage battery assembly ground lines are isolated from chassis (vehicle) ground, and an isolation circuit is provided in each main battery block to isolate battery state signals output to externally connected electrical equipment grounded to the chassis ground.

3. The power source apparatus as cited in claim 1 wherein the high-voltage battery assemblies are used as a vehicle power source to supply power to a motor that drives the vehicle, and the main battery block issues battery state signals to the vehicle-side.

4. The power source apparatus as cited in claim 1 wherein the connecting lines that connect a main battery block and sub-battery block are the detection lines that transmit voltage signals, which are detected by sub-battery block voltage detection circuitry, to the main battery block.

5. The power source apparatus as cited in claim 1 wherein the connecting lines that connect a main battery block and sub-battery block are a control line to send control signals from the main battery block to the voltage detection circuitry in the sub-battery block, and a voltage signal line to send voltage signals from the sub-battery block voltage detection circuitry to the main battery block.

6. The power source apparatus as cited in claim 5 wherein voltage detection circuitry in the sub-battery block is provided with a multiplexer to switch between batteries for voltage detection in the high-voltage battery assembly.

7. The power source apparatus as cited in claim 6 wherein voltage detection circuitry in the sub-battery block is provided with a multiplexer to switch between batteries for voltage detection in the high-voltage battery assembly, and an A/D converter to convert multiplexer output to a digital signal; and wherein voltage signals converted to digital signals by the A/D converter are transmitted to the main battery block via the voltage signal line.

8. The power source apparatus as cited in claim 1 further comprising a cooling plate having a main battery block and sub-battery block attached in a thermally coupled manner, and the CPU in the main battery block controls cooling by the cooling plate.

9. The power source apparatus as cited in claim 8 further comprising a plurality of battery units, and each battery unit is made up of a sub-battery block and a main battery block mounted on a cooling plate.

10. The power source apparatus as cited in claim 1 used in a power storage application.

11. A vehicle equipped with the power source apparatus as cited in claim 1.
